(19) United States
(12) Patent Application Publication
(10) Pub. No.: US 2012/0268354 A1
(43) Pub. Date: Oct. 25, 2012

(54) DISPLAY DEVICE

(75) Inventors: Seiichi Mizukoshi, Chigasaki-shi (JP); Nobuyki Mori, Asaka-shi (JP); Makoto Kohno, Yokohama-shi (JP)

(73) Assignee: Global Oled Technology LLC, Wilmington, DE (US)

(21) Appl. No.: 13/502,697

(22) PCT Filed: Oct. 20, 2010
(86) PCT No.: PCT/US10/53332

§ 371 Date: Jul. 13, 2012

(30) Foreign Application Priority Data
Oct. 21, 2009 (JP) 2009-242815

(51) Int. Cl. G09G 3/30

(52) U.S. Cl. 345/76

(57) ABSTRACT

Embodiments relate to an organic EL panel comprising a panel driving circuit for converting R′G′B′W data into driving signals which is supplied to a pixel circuit. At a RGB→R′G′B′W converting section, the bit width of input RGB data is greater than the bit width of converted R′G′B′W, and the characteristic curve of the amount of luminescent of W sub pixel for the input data of W in the said panel driving circuit is different from the R′G′B′ curve normalized at a luminance ratio necessary for a reproduction of white color with sub pixels of RGB. An appropriate process is carried out by the RGB→R′G′B′W converting section in accordance with the curve of input data from the panel driving circuit verses amount of luminescent to minimize an error which may be generated when a conversion is made.

### TECHNICAL FIELD

The present invention relates to a display device which constitutes a pixel using RGBW (red, green, blue, and white) sub-pixel and converts input RGB data into R′G′B′W data for display.

### BACKGROUND ART

FIG. 1 indicates an example of a dot array of a matrix type organic EL (OLED) panel in which three sub pixels (dots), the typical red, green, and blue (R, G, and B), form one color pixel. FIGS. 2 and 3 shows an example of a dot array of a matrix type organic EL panel in which, in addition to RGB, white (W) is also used. In FIG. 2, RGBW are arranged horizontally while RGBW are arranged altogether in a 2×2 color pixel in FIG. 3.

The RGBW type as a panel is intended to consume less power and be brighter because the W dots have higher emission efficiency than R, G, and B. Methods for realizing RGBW type panels includes a method which employs organic EL elements emitting each colors provided for each dot and a method which realizes dots other than W by laying red, green and blue optical filters on a white organic EL element.

FIG. 4 is a CIE 1931 chromaticity diagram which shows an example of a chromaticity of white (W) for use as a white color pixel along with three primary colors, the typical red, green, and blue (R, G, and B). Here, it is not necessary that the chromaticity of this W corresponds to the reference white color of a display.

FIG. 5 shows a method of converting an RGB input signal which can display reference white color of a display when R=1, G=1, and B=1, into an RGBW image signal.

First, when the emission color of W dot does not correspond to the reference white color of the display, the following calculation is applied to an input RGB signal for normalization to the emission color of W dot (S11).

$$[ \begin{matrix}Rn \\ Gn \\ Bn\end{matrix} ] = [ \begin{matrix}a & 0 & 0 \\ 0 & b & 0 \\ 0 & 0 & c\end{matrix} ] \times [ \begin{matrix}R \\ G \\ B\end{matrix} ] \qquad [ Equation 1 ]$$

Here, R, G, and B represent input signals; Rn, Gn, and Bn represent normalized red, green, and blue signals; and a, b, and c are coefficients which are selected such that brightness and chromaticity equal to W=1 can be obtained when R=1/a, G=1/b, and B=1/c respectively.

The following are possible examples of the most basic expressions for calculating S, F2, and F3

S=min(R n, Gn, Bn) Equation 2

F2(S)=−S Equation 3

F2(S)=S Equation 4

In regards to (Rn, Gn, Bn) obtained from S11, at this time, S (a normalized minimum RGB element) is calculated in step 12 by equation 2 (step 12), and the obtained S is subtracted from Rn, Gn, Bn to obtain Rn′, Gn′, Bn′ (S13, S14). S is output as white value (Wh) as is (S15).

Here, as the pixel color to be displayed approaches an achromatic color, the ratio at which W dot is caused to emit light increases. Accordingly, as the ratio of colors near to achromatic colors increases in an image to be displayed, the power consumption of the panel is lowered compared to when only RGB dots are used.

Also, in the same way as for the normalization to the emission color of W dot, when the emission color of W dot does not correspond to the reference white color of the display, the final normalization to the reference white color is carried out (S16). The following equations are used for the final normalization to the reference white color.

$$[ \begin{matrix}{R}^{′} \\ {G}^{′} \\ {B}^{′}\end{matrix} ] = [ \begin{matrix}1 / a & 0 & 0 \\ 0 & 1 / b & 0 \\ 0 & 0 & 1 / c\end{matrix} ] \times [ \begin{matrix}{Rn}^{′} \\ {Gn}^{′} \\ {Bn}^{′}\end{matrix} ] \qquad [ Equation 5 ]$$

As normal images are only rarely constituted by just saturated colors, W dots are used in most cases. Consequently, the overall power consumption is on average lower than when only RGB color pixels are used.

Moreover, when M is a constant which satisfies 0≦M≦1 and the following equations are used for F2 and F3, the usage ratio of W dots varies depending on the value of M.

F2(S)=−MS Equation 6

F3(S)=MS Equation 7

In terms of power consumption, it is the most desirable to use M=1, that is, a 100% usage rate. In terms of visual resolution, however, it is preferable to select the value of M such that all of RGBW emit light (see patent reference 1).

FIG. 6 is a diagram of a conversion method at this time without normalization.

In regards to input signals, the minimum value S is obtained from RGB (S21) and the constant M is multiplied by the obtained value S to determine white (Wh) (S22). This Wh is output and S is subtracted from each RGB value (S23) to obtain the converted R′, G′, and B′.

Here, consider the quantum error when a simple conversion is conducted with both t and u as natural numbers which satisfy t>u, input RGB as t bit for each color, and R′G′B′W as u bit for each color. In the input RGB, the high-order u bit is an integer portion while the low-order (t−u) bit is a fractional portion. The converted R′G′B′W is considered as integer numbers. If the amount of luminescent is proportional to input data, the theoretical amount of luminescent for each color is as below:

Lr1=krR Equation 8

Lg1=kgG Equation 9

Lb1=kbB Equation 10

(kr, kg, kb are proportional constant)

Also, the amount of luminescent after conversion is as below using each R element, G element and B element of R′G′B′W:

Lr2=krR′+krW Equation 11

Lg2=kgG′+kgW Equation 12

Lb2=kbB′+kbW Equation 13

The differences in the amount of luminescent of each color, ΔLr, ΔLg, and ΔLb are indicated as below:

ΔLr=Lr1−Lr2=kr(R−(R′+W)) Equation 14

ΔLg=Lg1−Lg2=kg(G−(G′+W)) Equation 15

ΔLb=Lb1−Lb2=kb(B−(B′+W)) Equation 16

The R′, G′, B′ and W values are selected so that the minimum |ΔLr|, |ΔLg|, and |ΔLb| are obtained. However, up to 0.5 in errors are observed in |ΔLr/kr|, |ΔLg/kg|, and |ΔLb/kb|, because the R′, G′, B′ and W values are integer numbers which do not have bit corresponding to the fractional portions of R, G, and B.

### PRIOR ART REFERENCES

### Patent References

[Patent Reference 1] Japanese Published Unexamined Application No. 2006-003475

### General Description of the Invention

### Problems to be Solved by the Invention

In a display device having RGBW sub pixels, when RGB signals with bit width greater than the input bit width of RGBW of a panel is input, it displays without disturbing the gradation of input signals as much as possible.

### Means for Solving the Problems

The present invention is a display device which constitutes a pixel using RGBW (red, green, blue, and white) sub-pixel and converts input RGB data into R′G′B′W data for display, comprising the first conversion means for converting the input RGB data into R′G′B′W data, the second conversion means for converting the R′G′B′W data into driving signals of the R′G′B′W data which is supplied to a display panel, characterized in that the bit width of input RGB data is greater than the bit width of converted R′G′B′W in the said first conversion means, and the characteristic curve of the amount of luminescent of W sub pixel for the input data of W of the second conversion means is different from the R′G′B′ curve normalized at a luminance ratio necessary for a reproduction of white color with sub pixels of RGB.

Also, in the said second conversion means, it is preferred that the characteristic curve of the amount of luminescent for the input data of R′G′B′ which is normalized at a luminance ratio necessary for a reproduction of white color with sub pixels of RGB is a straight line and the characteristic curve of the amount of luminescent of W sub pixel for the input data of W is a straight line having a different angle from the characteristic curve of R′G′B′.

Also, in the said second conversion means, it is preferred that the characteristic curve of the amount of luminescent for the input data of R′G′B′ which is normalized at a luminance ratio necessary for a reproduction of white color with sub pixels of RGB is a straight line while the characteristic curve of the amount of luminescent of W sub pixel for the input data of W is a combination of a plurality of straight lines having different angles from the angle of the characteristic curve of the said R′G′B′.

Moreover, when the bit width of RGB data which is input in the said first conversion means is t and the bit width of the converted R′G′B′W is u, it is preferred that the angle of at least one straight line of the characteristics of W in the said second conversion means is (2n−1)/2(t−u) (n is a positive integer).

Also, it is preferred that the angle of the characteristic curve of the amount of luminescent of W sub pixel for input data of W in the said second conversion means is moderate compared to that of R′G′B, and when the white element obtained from calculation of input RGB in the said first conversion means is less than the maximum amount of luminescent of W sub pixel, the usage rate of white (W) is made 100% while when the white element is greater than the maximum amount of luminescent of W sub pixel, it is reproduced by the combination of W lighted at its maximum brightness and R′G′B′ sub pixels.

In the said first conversion means, it is preferred that the R′G′B′ value and W value are determined so that the absolute value of the sum of values obtained from multiplying weight by each difference between the amount of luminescent of each RGB obtained from calculating each input RGB data and the amount of luminescent of RGB obtained from calculating converted R′G′B′W data is minimum.

Also, in the said first conversion means, it is preferred that R′G′B′ value and W value are determined so that the differences of chromaticity calculated from the amount of luminescent of each RGB obtained from calculating each input RGB data and the amount of luminescent of each RGB obtained from calculating each RGB element in converted R′G′B′W data is minimum.

### Advantages of the Invention

Display is achieved without disturbing gradation for input signals having greater gradation numbers than the maximum gradation numbers of a display panel.

### BRIEF DESCRIPTION OF THE DRAWINGS

FIG. 1 is a diagram showing an example of sub pixel constitution of an organic EL panel using RGB dots.

FIG. 2 is a diagram showing an example of sub pixel constitution of an organic EL panel using RGBW dots.

FIG. 3 is a diagram showing an example of sub pixel constitution of an organic EL panel using RGBW dots.

FIG. 4 is a diagram showing chromaticity position of RGBW primary colors in a CIE1931 chromaticity diagram.

FIG. 5 is a diagram indicating an example of process converting a RGB input signal into a RGBW image signal.

FIG. 6 is a diagram indicating another example of process converting a RGB input signal into a RGBW image signal.

FIG. 7 is a diagram illustrating a conversion characteristic of W.

FIG. 8 is a diagram illustrating a specific example of converting W.

FIG. 9 is a diagram showing an example of the status of an input RGB and converted R′G′B′W.

FIG. 10 is a diagram showing another example of a status of an input RGB and converted R′G′B′W.

FIG. 11 is a diagram showing another example of a status of an input RGB and converted R′G′B′W.

FIG. 12 is a diagram indicating another example of a status of an input RGB and converted R′G′B′W.

FIG. 13 is a diagram indicating another example of a status of an input RGB and converted R′G′B′W.

FIG. 14 is a diagram showing another example of a status of an input RGB and converted R′G′B′W.

FIG. 15 is a diagram indicating a constructive example for deciding W.

FIG. 16 is a diagram indicating a constructive example for deciding W.

FIG. 17 is a diagram illustrating a conversion characteristic of W.

FIG. 18 is a diagram showing the constitution for realizing FIG. 17.

FIG. 19 is a diagram illustrating a conversion characteristic of W.

FIG. 20 is a diagram indicating usage of W and RGB for monochrome.

FIG. 21 is a diagram showing another example of a status of an input RGB and converted R′G′B′W.

FIG. 22 is a diagram showing another example of a status of an input RGB and converted R′G′B′W.

FIG. 23 is a diagram illustrating a constitution of a display device.

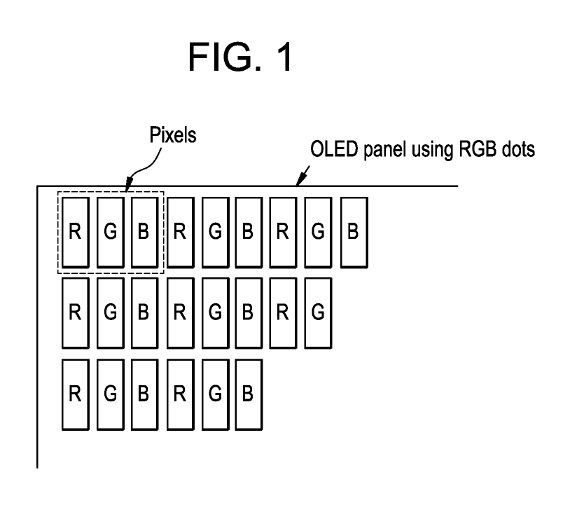

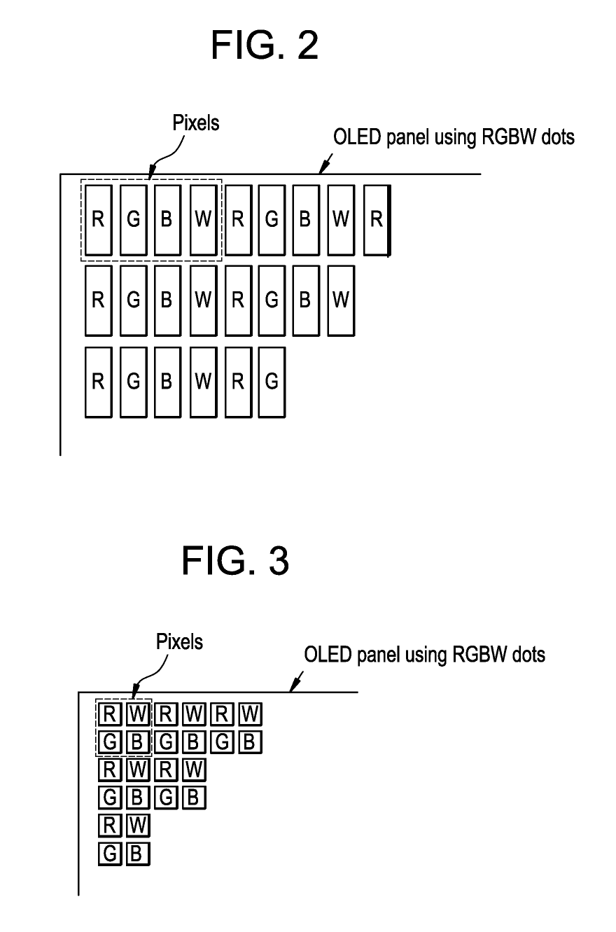

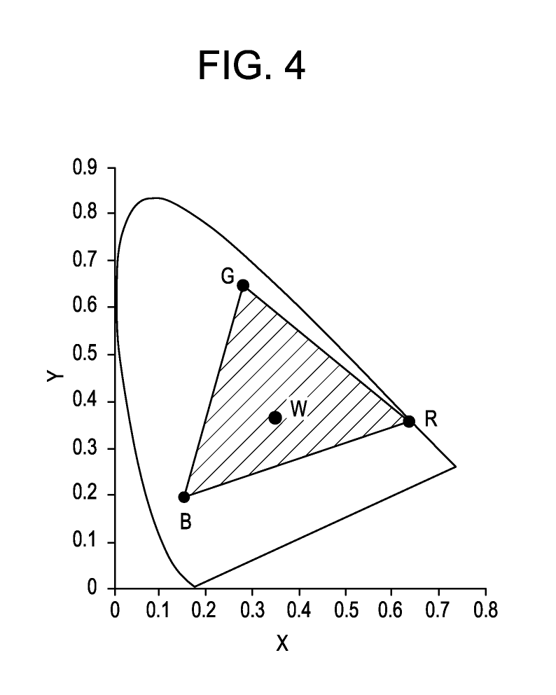

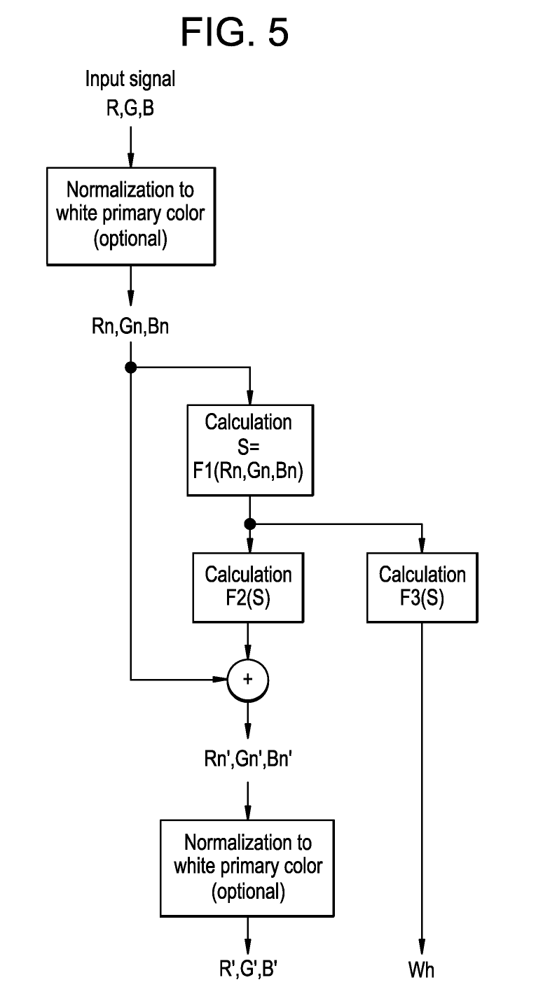

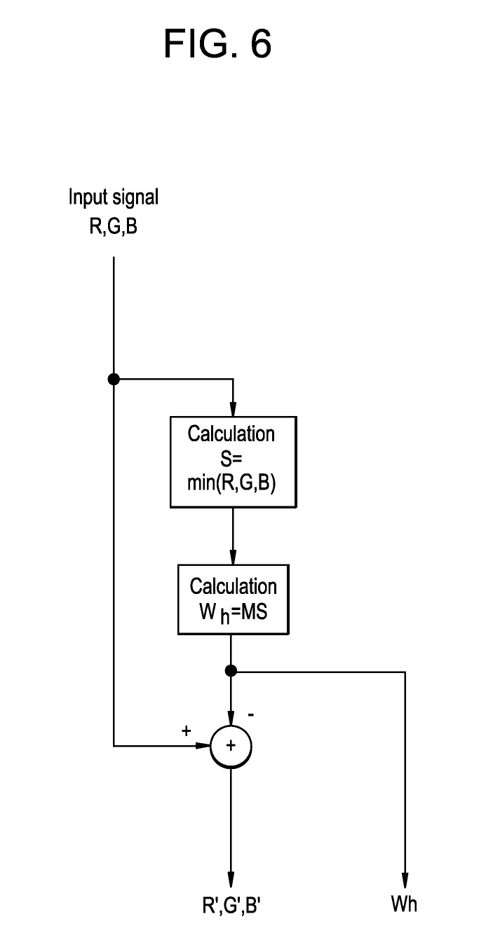

### MODE FOR CARRYING OUT THE INVENTION

An embodiment of the present invention will be explained based on the figures below.

### Explanation of Contents of a Conversion

According to this embodiment, conversions from RGB signals into RGBW signals are made. At this time, the characteristic curve of the amount of luminescent of sub pixel for the input data of W in a dark part is made moderate compared to the curve of R′G′B′ which is normalized at a luminance ratio necessary for a reproduction of white color with sub pixels of RGB while the characteristic curve of the amount of luminescent of sub pixel for the input data of W in a bright part is made acute compared to the curve of R′G′B′. When all the other conditions are the same as the conditions described above, the theoretical amount of luminescent of each color using input RGB is as indicated in equations 8-10. The amount of luminescent after the conversion is indicated as below when the characteristic curve of W is expressed as a function f(W):

Lr2=krR′+krf(W) Equation 17

Lg2=kgG′+kgf(W) Equation 18

Lb2=kbB′+kbf(W) Equation 19

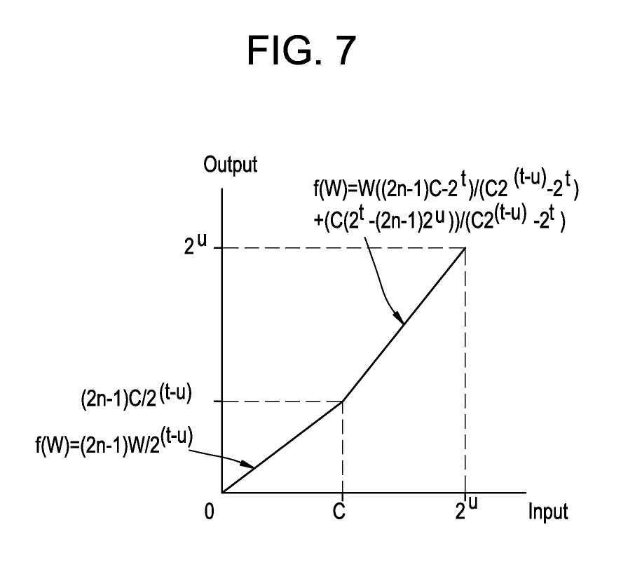

Here, a combination of two straight lines as indicated in FIG. 7 is considered as f(W).

When n is an arbitrary positive integer, f(W) is indicated as below within a range satisfying 0≦W≦C:

f(W)=(2n−1)W/2^{(t-u)} Equation 20

Here, t is a bit number for input data and u is a bit number for output data, and for example, when a W calculated from inputted RGB data (input data in FIG. 7) is t=6 bit, the bit number of output data f(W) is u=4 bit and n=2, the straight line in Equation 20 is expressed as f(W)=(3/4) W.

Also, within the range satisfying 0≦W≦C, the Equations 17-19 can be modified as below:

Lr2=kr(R′+(2n−1)W/2^{(t-u)}) Equation 21

Lg2=kg(G′+(2n−1)W/2^{(t-u)}) Equation 22

Lb2=kb(B′+(2n−1)W/2^{(t-u)}) Equation 23

When W is an integer, p is an integer which satisfies 0≦p≦2^{(t-u)}, the Equations 21-23 is expressed as follows:

Lr2=kr(R′+W+p/2^{(t-u)}) Equation 24

Lg2=kg(G′+W+p/2^{(t-u)}) Equation 25

Lb2=kb(B′+W+p/2^{(t-u)}) Equation 26

Therefore, the errors in the amount of luminescent in each color, ΔLr, ΔLg, ΔLb, are expressed as below:

ΔLr=Lr1−Lr2=kr(R−(R′+W′+p/2^{(t-u)})) Equation 27

ΔLg=Lg1−Lg2=kg(G−(G′+W′+p/2^{(t-u)})) Equation 28

ΔLb=Lb1−Lb2=kb(B−(B′+W′+p/2^{(t-u)})) Equation 27

Here, |ΔLr/kr|, |ΔLg/kg|, and |ΔLb/kb| are 0.5 or less because R′, G′, B′ values are selected so that |ΔLr|, |ΔLg|, |ΔLb| become minimum. Consequently, the error becomes smaller as the RGB value after the decimal point becomes closer to p/2^{(t-u)}. A fractional portion of input RGB can be expressed as q/2^{(t-u)} as an integer which satisfies 0≦q≦2^{(t-u)}. Thus, by selecting a W value to realize p=q for a fractional portion of a certain color, an error can be made 0 in regards to the certain color.

Next, consider the case when W is within the range satisfying C≦W≦2^{u}.

Within this range, f(W) is expressed as below:

f(W)=W((2n−1)C−2^{t})/(C2^{(t-u)}−2^{t})+(C(2^{t}−(2n−1)2^{u}))/(C2^{(t-u)}−2^{t}) Equation 30

For example, when t=6, u=4, n=2 and C=8 as before, the straight line in Equation 30 is expressed as f(W)=(5/4)W−4.

The amount of luminescent for each color after a conversion is as below:

Lr2=kr(R′+(W((2n−1)C−2^{t})/(C2^{(t-u)}−2^{t})+(C(2^{t}−(2n−1)2^{u}))/(C2^{(t-u)}−2^{t}))) Equation 31

Lg2=kg(G′+(W((2n−1)C−2^{t})/(C2^{(t-u)}−2^{t})+(C(2^{t}−(2n−1)2^{u}))/(C2^{(t-u)}−2^{t}))) Equation 32

Lb2=kb(B′+(W((2n−1)C−2^{t})/(C2^{(t-u)}−2^{t})+(C(2^{t}−(2n−1)2^{u}))/(C2^{(t-u)}−2^{t}))) Equation 33

When W is an integer and d is a real number which satisfies |d|≦0.5, the equations 31-33 can be expressed as below:

Lr2=kr(R′+W+d) Equation 34

Lg2=kg(G′+W+d) Equation 35

Lb2=kb(B′+W+d) Equation 36

Therefore, the errors in the amount of luminescent in each color, ΔLr, ΔLg, ΔLb, are expressed as below:

ΔLr=Lr1−Lr2=kr(R−(R′+W′+d)) Equation 37

ΔLg=Lg1−Lg2=kg(G−(G′+W′+d)) Equation 37

ΔLb=Lb1−Lb2=kb(B−(B′+W′+d)) Equation 37

Even in this case, the maximum error is 0.5 and will not become worse than the case when the characteristic curve of W is a straight line as with R′, G′, B′ by selecting R′, G′, B′ values so that ΔLr, ΔLg, ΔLb will become minimum.

As explained above, by making the characteristic curve of W as indicated in FIG. 7, the gradation characteristics for the portion expressed by f(W)=(2n−1)W/2(t−u) can be improved without sacrificing errors in other parts. That is, it becomes possible to select R′, G′, B′ values which can best compensate for the lower bit which is to be discarded because the bit number of output data is smaller than the bit number of input data.

### SPECIFIC EXAMPLES

Effect of the present invention will be explained below using specific numbers. Also, it is based on the premise that W's usage rate M is made as close as possible to 100% (M≈1).

### EXAMPLE 1

### Fractional Portions of Input RGB are all Identical Values

Consider the case when the fractional portions of input RGB are all identical in all colors.

(1) Conventional Method

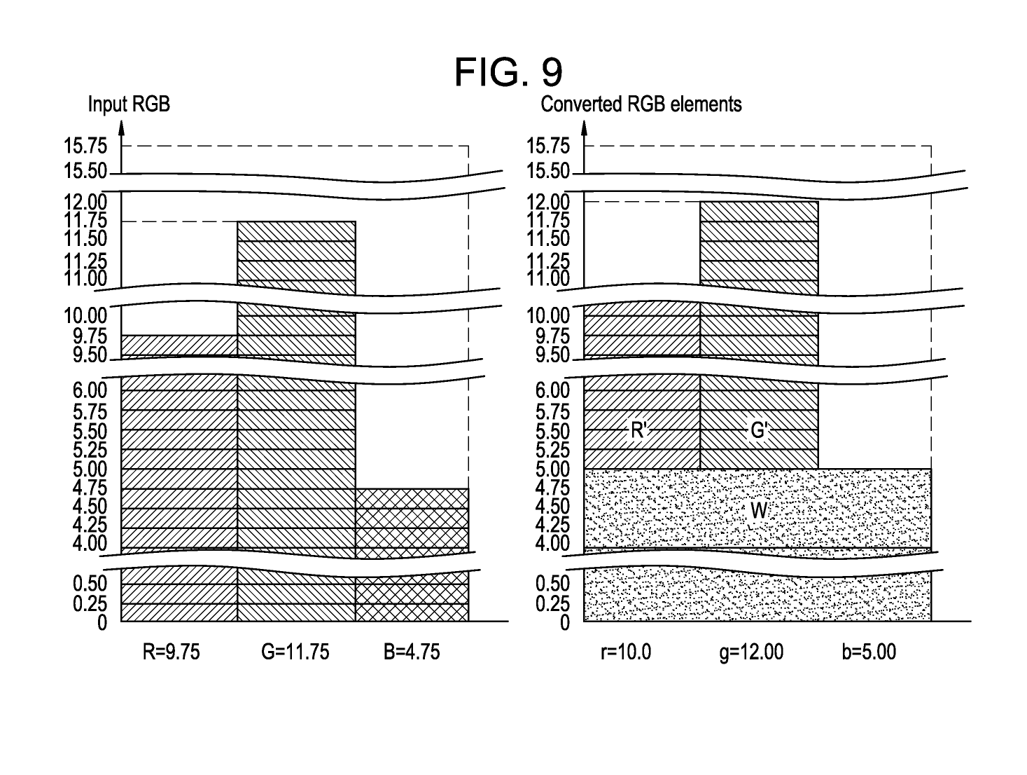

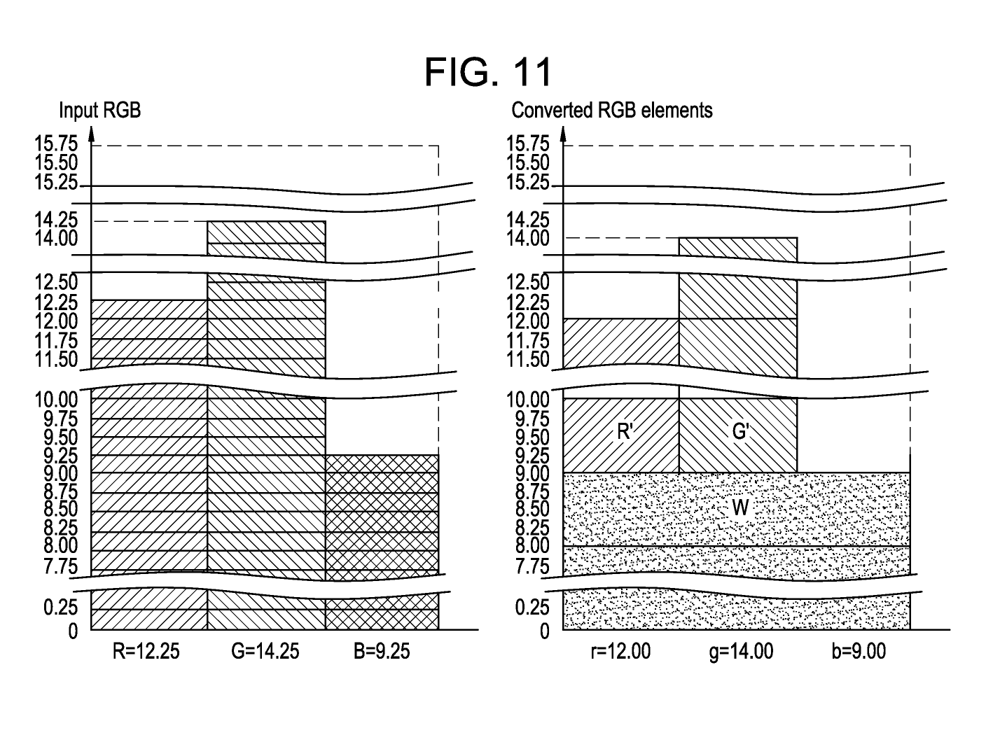

FIGS. 9 and 11 are examples of obtaining R′G′B′W values with 4-bit integer for each color from RGB input signals with a 4-bit integer portion and a 2-bit fractional portion, comprising a total of 6 bits for each color using a conventional method.

a) When input values are: R=9.75, G=11.75, B=4.75 (FIG. 9)

When the maximum integer which does not exceed x against a real number x is expressed by “[x]” to obtain W:

W=[min(9.7 5, 11.75, 4.75)+0.5]=[5.25]=5

The reason for adding 0.5 here is to round off fractions.

The R′, G′, B′ values which were rounded off as before are expressed as below:

R′=[R−W+0.5]=[9.75−5+0.5]=[5.25]=5

G′=[G−W+0.5]=[11.75−5+0.5]=[7.25]=7

B′=[B−W+0.5]=[4.75−5+0.5]=[0.25]=0

The RGB elements, r, g, b are obtained from the following equations:

r=R′+W=5+5=10

g=G′+W=7+5=12

b=B′+W=0+5=5

For an input RGB, an error of 0.25 is occurred for each color.

b) When input values are: R=12.25, G=14.25, B=9.25 (FIG. 11)

It is expressed as below:

W=[min(12.25, 14.25, 9.25)+0.5]=[9.75]=9

R′, G′, B′ values are as follows:

R′=[R−W+0.5]=[12.25−9+0.5]=[3.75]=3

G′=[G−W+0.5]=[14.25−9+0.5]=[5.75]=5

B′=[B−W+0.5]=[9.25−9+0.5]=[0.75]=0

The RGB elements, r, g, b are obtained from the following equations:

r=R′+W=3+9=12

g=G′+W=5+9=14

b=B′+W=0+9=9

For an input RGB, an error of 0.25 is occurred for each color.

(2) When a characteristic curve of W is a combination of straight lines

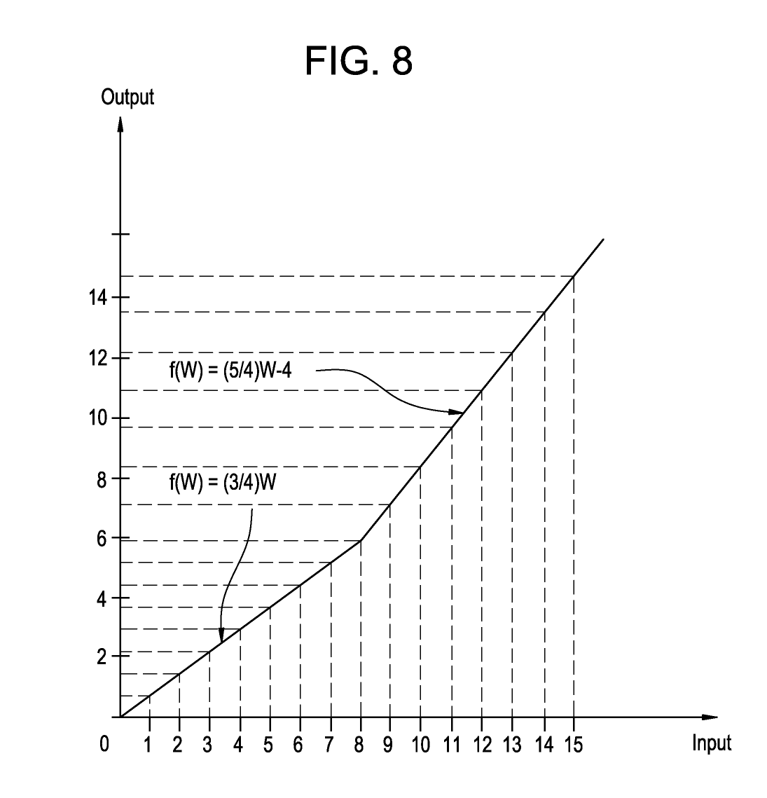

An example of a characteristic curve of W which is shown in FIG. 8 is explained next.

a) When input values are: R=9.75, G=11.75, B=4.75

W is within the range satisfying 0≦W≦8 because min(R, G, B)=B=4.75 and is smaller than f (8)=6.

Within this range, f(W) is expressed as below:

f(W)=(3/4)W Equation 40

An integer Wo which satisfies f(Wo) that is equal to or less than 4.75+0.5 and closest to 4.75 is obtained as below:

Wo=[f−1(min(R, G, B)+0.5)]=[((4/3)×(4.75+0.5))=[7.00]=7

Here, f(Wo) is expressed as below:

f(Wo)=f(7)=(3/4)×7=5.25. The difference from B is: 4.75−5.25=−0.50.

A W which is equal to or greater than Wo−(2(t−u)−1) and equal to or less than Wo, and has a fractional portion of 0.75 is 5. R′, G′, B′ values are obtained as below using f (5)=3.75:

R′=[R−f(5)+0.5]=[9.75−3.75+0.5]=[6.5]=6

G′=[G−f(5)+0.5]=[11.75−3.75+0.5]=[8.5]=8

B′=[B−f(5)+0.5]=[4.75−3.75+0.5]=[1.5]=1

The RGB elements, r, g, b are obtained from the following equations:

r=R′+f(5)=6+3.75=9.75

g=G′+f(5)=8+3.75=11.75

b=B′+f(5)=1+3.75=4.75

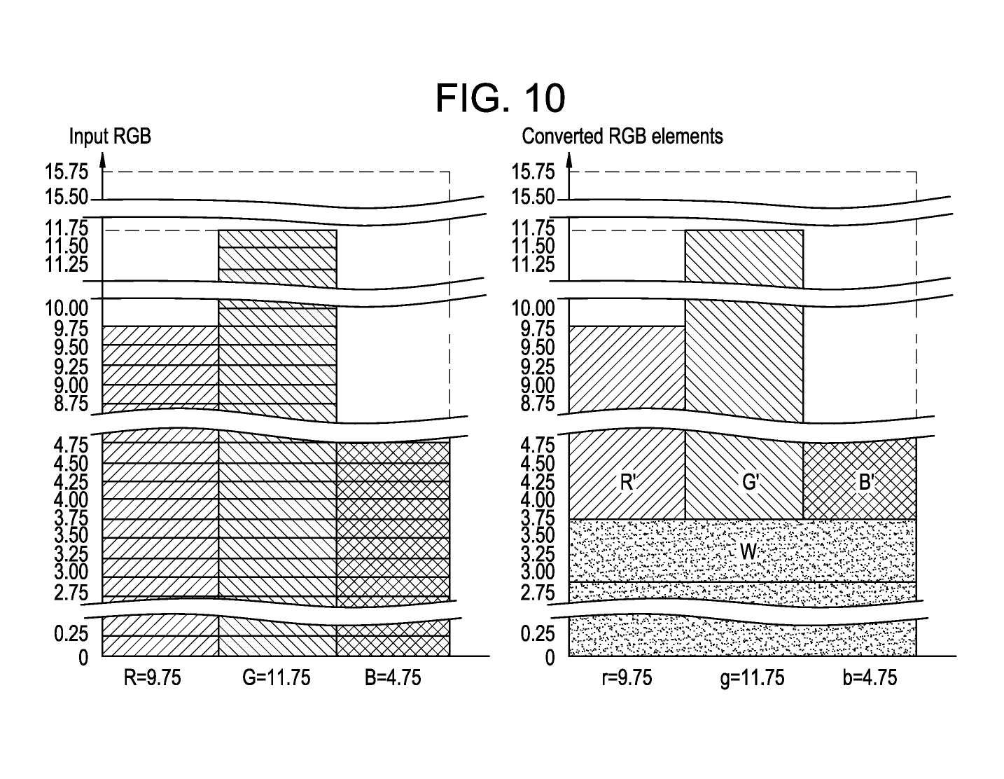

Errors against input RGB for each color are 0. This is illustrated in FIG. 10.

b) When input values are: R=12.25, G=14.25, B=9.25

W is within the range satisfying 8≦W≦16 because min(R, G, B)=B=9.25 and is greater than f (8)=6. Within this range, f(W) is expressed in the following equation.

f(W)=(5/4)W−4 Equation 41

Within this range, an integer Wo which satisfies f(Wo) that is equal to or less than 9.25+0.5 and closest to 9.25 is obtained as below:

Wo=[f−1(min(R, G, B)+0.5)]=[(B+0.5+4)×(4/5)]=[(9.75+4)×(4/5)]=[11.00]=11

Here, f(Wo) is expressed as below:

f(Wo)=f(11)=9.75. The error between B is: 9.25−9.75=−0.50.

A W which is equal to or greater than Wo−(2^{(t-u)}−1) and equal to or less than Wo, and has a fractional portion of 0.25 is 9. R′, G′, B′ values are obtained as below using f (9)=7.25:

R′=[R−f(9)+0.5]=[12.25−7.25+0.5]=[5.5]=5

G′=[G−f(9)+0.5]=[14.25−7.25+0.5]=[7.5]=7

B′=[B−f(9)+0.5]=[9.25−7.25+0.5]=[2.5]=2

The RGB elements, r, g, b here are obtained from the following equations:

r=R′+f(9)=5+7.25=12.25

g=G′+f(9)=7+7.25=14.25

b=B′+f(9)=2+7.25=9.25

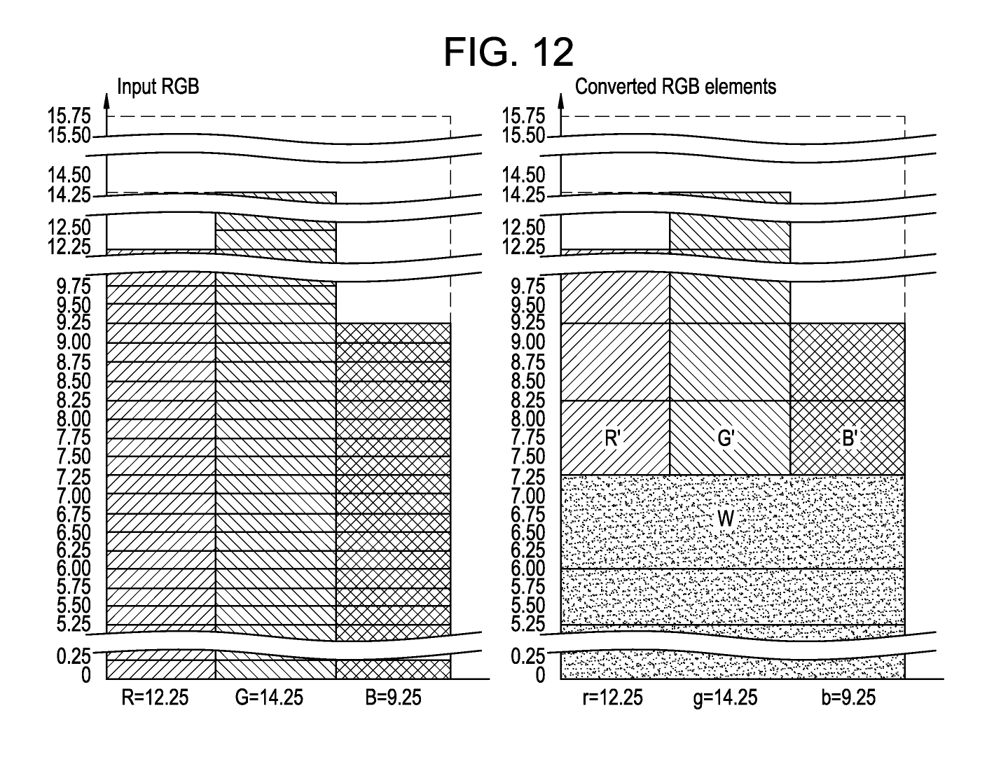

Errors against input RGB in each color are 0. This is illustrated in FIG. 12.

In this example, W satisfies the condition of f(W)=(2n−1)W/2^{(t-u)} (n is a positive integer) even when it is at a portion greater than a bending point C of f(W). Therefore, the error is 0.

Moreover, in this example, the error is 0 for all colors because the fractional portions are identical for all 3 colors. That is, a W which can express the original input gradation as is can be found. As a special example, when a monochrome image having the same RGB values is input, a display corresponding to the gradation of input RGB is created constantly.

### Example 2

### Fractional Portions of Input RGB are Different Values

When fractional portions of each color are different values, it is preferred that the method of selecting W values are modified as below depending on what is considered as important in terms of image fidelity.

When [f−1(min(R, G, B))]≦C, R′G′B′ values and W values are determined so that the absolute value of the sum of each differences between each input RGB data and each RGB elements within the converted R′G′B′ W data is minimum.

That is, there are 2^{(t-u)} ways from 0 to 2^{(t-u)}−1 for p in the fractional portions of W+p/2(t−u). To make the usage rate of W closer to 100% (M=1), select the minimum W by obtaining the absolute value of the sum of differences for all values that is equal to or less than Wo which satisfies Wo=[f−1(min(R, G, B)+0.5)] and equal to or greater than Wo−(2(t−u)−1).

Consider the case when input values are R=9.75, G=11.50, B=4.75 in the same condition as Example 1 below.

W is within the range satisfying 0≦W≦8 because min(R, G, B)=B=4.75 and is smaller than f (8)=6. Therefore, an integer Wo which satisfies f(Wo) that is equal to or less than 4.75 and closest to 4.75 is obtained as below:

Wo=[f−1(min(R, G, B)+0.5)]=[((4/3)×(4.75+0.5))=[7.00]=7

Here, f(Wo) is expressed as below:

f(Wo)=f(7)=(3/4)×7=5.25. The difference from B is: 4.75−5.25=−0.50.

Using this f(Wo), R′, G′, B′ values are expressed in the equations below:

R′=[R−f(Wo)+0.5]=[9.75−5.25+0.5]=[5.0]=5

G′=[G−f(Wo)+0.5]=[11.50−5.25+0.5]=[6.75]=6

B′=[B−f(Wo)+0.5]=[4.75−5.25+0.5]=[0.00]=0

RGB elements, r, g, b, are obtained from the equations below:

r=R′+f(Wo)=5+5.25=10.25

g=G′+f(Wo)=6+5.25=11.25

b=B′+f(Wo)=0+5.25=5.25

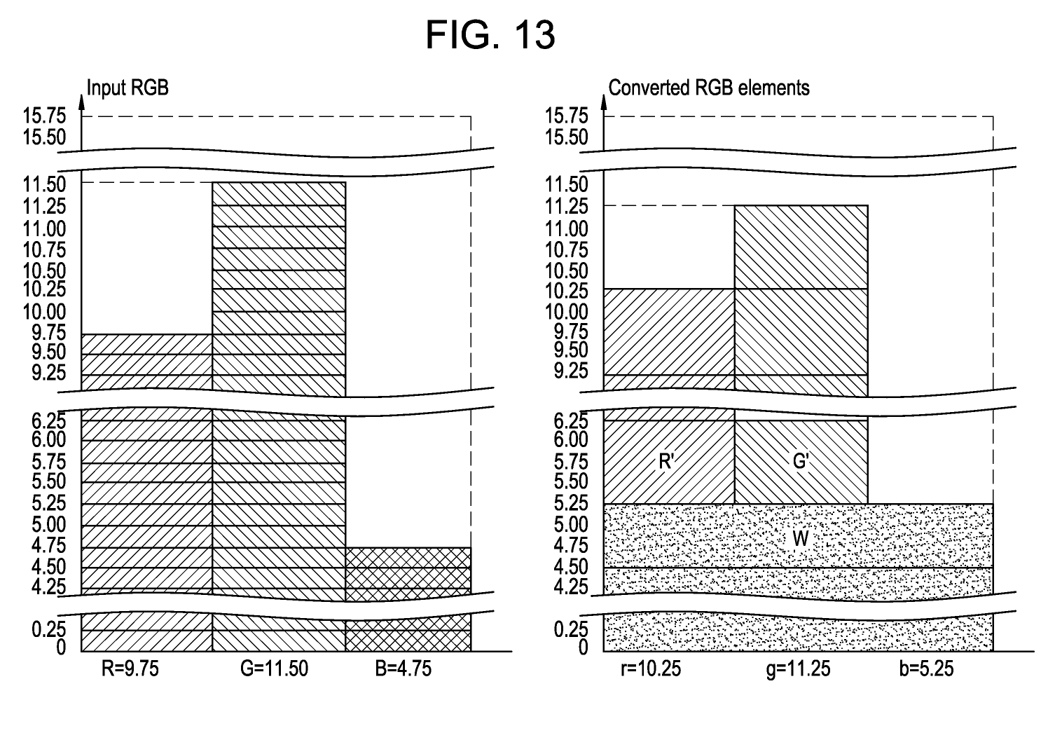

This is illustrated in FIG. 13.

Here, the differences between the input RGB values and the values of converted RGB elements are obtained as below:

R−r=9.75−10.25=−0.50

G−g=11.50−11.25=0.25

B−b=4.75−5.25=−0.50

The absolute value of the sum of the differences between each input RGB and converted RGB elements is as below:

|(R−r)+(G−g)+(B−b)|=|−0.50+0.25−0.50|=0.75

As before, a W value which is equal to or less than WO and equal to or greater than Wo−(2(t−u)−1), that is, the absolute value of the sum of differences of each cases is obtained using (Wo−1)=6, (Wo−2)=5, (Wo−3)=4 as indicated in the following table:

TABLE 1

| W | 4 | 5 | 6 | 7 |
|---|---|---|---|---|
| R′ | 7 | 6 | 5 | 5 |
| G′ | 9 | 8 | 7 | 6 |
| B′ | 2 | 1 | 0 | 0 |
| r | 10.00 | 9.75 | 9.50 | 10.25 |
| g | 12.00 | 11.75 | 11.50 | 11.25 |
| b | 5.00 | 4.75 | 4.50 | 5.25 |
| R − r | −0.25 | 0.00 | 0.25 | −0.50 |
| G − g | −0.50 | −0.25 | 0.00 | 0.25 |
| B − b | −0.25 | 0.00 | 0.25 | −0.50 |
| \| (R − r) + | 1.00 | 0.25 | 0.50 | 0.75 |
| (G − g) + | | | | |
| (B − b) \| | | | | |

A W value taking the minimum value of 0.25 is (WO−2)=5.

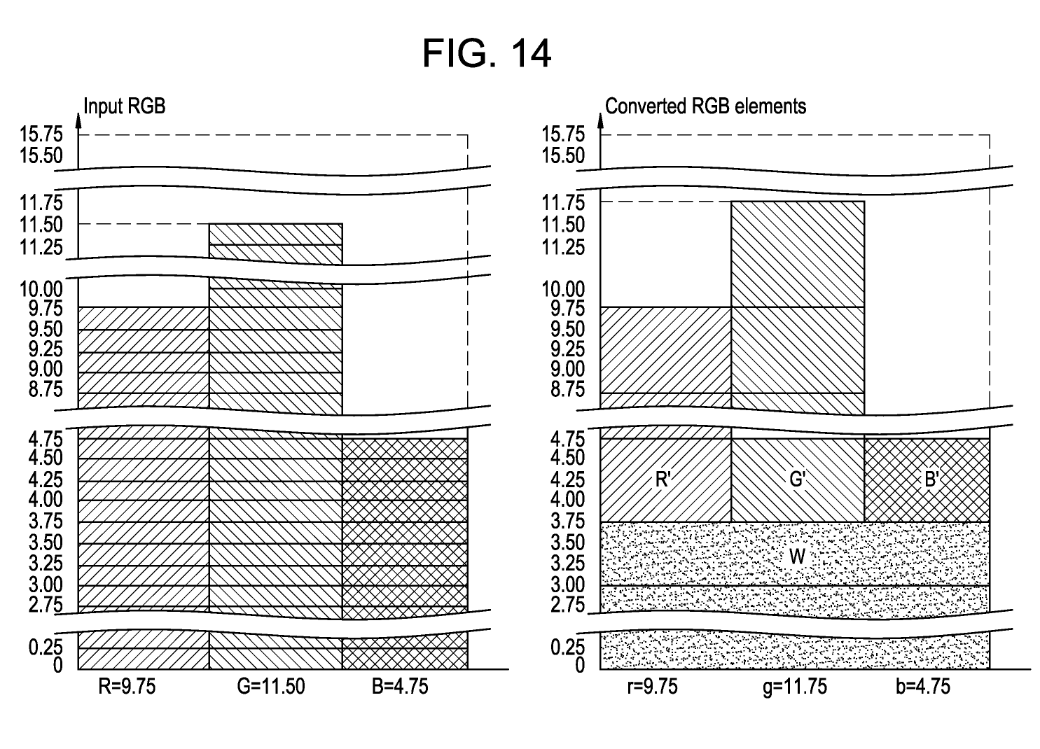

That is, the absolute value of the sum of each differences between each input RGB data and each RGB element in the converted R′G′B′W data becomes minimum by realizing W=5. This is illustrated in FIG. 14.

Each difference may be multiplied by weight. For example, luminance component is greatly contributed to visual gradation characteristics but size of luminance component is different for each color. Therefore, it is preferred to multiply weight which corresponds to luminance component of each color. For example, the following table is obtained when the weights for each color R, G, B, are 0.3, 0.6, 0.1 respectively.

TABLE 2

| W | 4 | 5 | 6 | 7 |
|---|---|---|---|---|
| R′ | 7 | 6 | 5 | 5 |
| G′ | 9 | 8 | 7 | 6 |
| B′ | 2 | 1 | 0 | 0 |
| r | 10.00 | 9.75 | 9.50 | 10.25 |
| g | 12.00 | 11.75 | 11.50 | 11.25 |
| b | 5.00 | 4.75 | 4.50 | 5.25 |
| R − r | −0.25 | 0.00 | 0.25 | −0.50 |
| G − g | −0.50 | −0.25 | 0.00 | 0.25 |
| B − b | −0.25 | 0.00 | 0.25 | −0.50 |
| \| 0.3(R − r) + | 0.40 | 0.15 | 0.10 | 0.05 |
| 0.6 (G − g) + | | | | |
| 0.1 (B − b) | | | | |

In the table, a W value which takes the minimum value of 0.05 is 7.

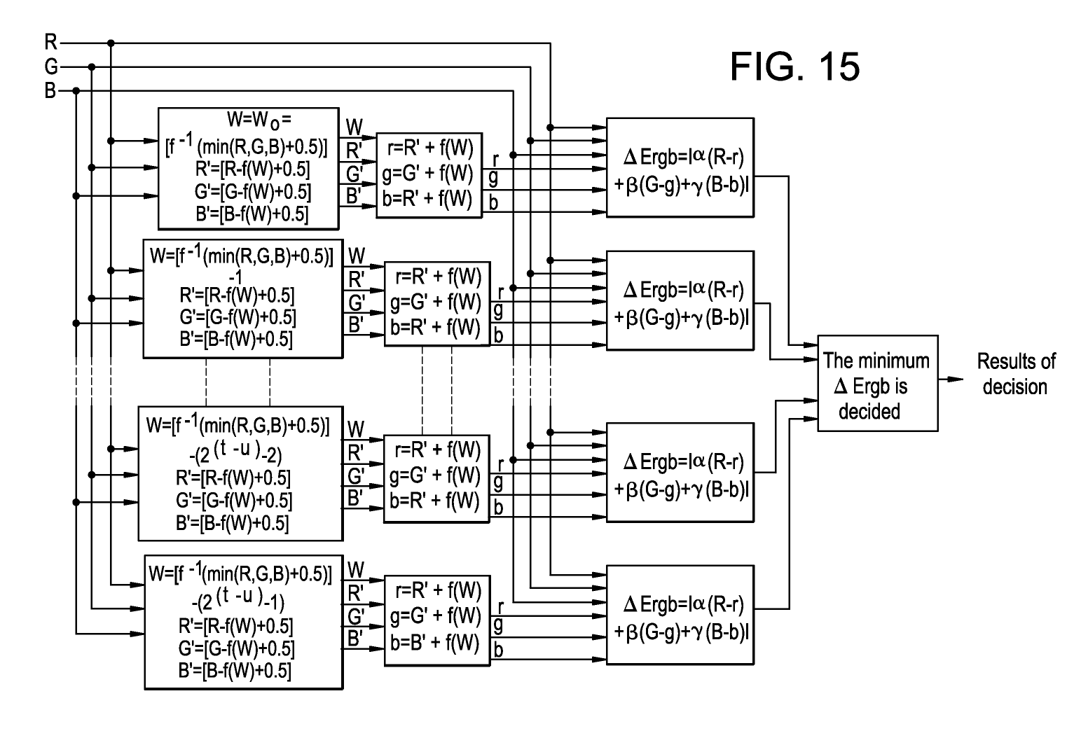

FIG. 15 is a block diagram of a deciding part.

First, the minimum value is selected from input RGB and W is determined from the equation, W=Wo=[f−1(min(R, G, B))+0.5]. As for W here, values which differs by 1 and within the range 1˜2(t−u)−1 corresponding to bits to be rounded up are subtracted from output data to calculate individual values.

Using each W obtained separately, R′, G′, B′ are calculated separately.

Next, r, g, b are calculated using the obtained W, R′, G′B′.

The difference between the calculated r, g, b obtained above and input data as RGB are calculated and the absolute values of each difference are added with weighing by weights α, β, γ.

Then the minimum value is decided in regards to the error ΔErgb of W within the range of Wo˜Wo−(2(t−u)−1) to determine the best R′, G′, B′, W.

Moreover, the luminance component of G is greater than that of other colors and thus when the weight of G is 0 and the weight of other color is 0, G's error is made minimum to realize simplified calculation and a decision circuit.

Also, color differences may be made minimum with a color specification system such as L*u*v* or L*a*b*. Both are a color specification system recommended by CIE in 1976 and are defined so that a constant distance within a color specification system has perceptually equal interval difference in any area. Therefore, obtain pre- and post-conversion L*u*v* or L*a*b* and select a fractional value which will make a color difference defined in the following equations a minimum value.

ΔEuv=((ΔL*)2+(Δu*)2+(Δv*)2)1/2 Equation 42

Here, ΔL*, Δu*, Δy* are differences between pre- and post-conversion L*, u*, v*.

ΔEab=((ΔL*)2+(Δa*)2+(Δ b*)2)1/2 Equation 43

Here, ΔL*, Δa*, Δb* are differences between pre- and post-conversion L*, a*, b*.

Also, to simplify, only a luminance difference ΔL* may be calculated to select a W value which makes it a minimum value.

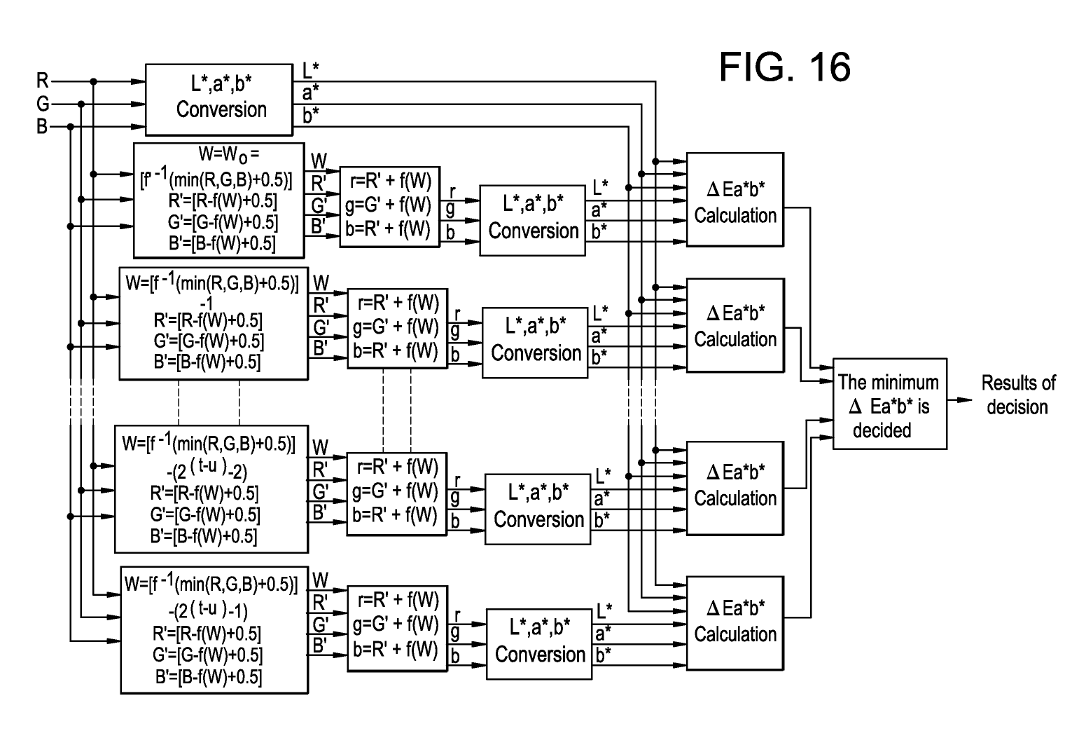

FIG. 16 is a block diagram of a deciding part in a color specification system such as L*a*b*. The error between L*a*b* converted r, g, b with a W within the range of [f−1(min(R [symbol] G [symbol] B))+0.5]˜[f−1(min(R [symbol] G [symbol] B))+0.5]−(2(t−u)−1) and L*a*b* converted input RGB is calculated.

As described above, two different ways of selecting a W value are explained. Only a W value which satisfies the range of f(W)=(2n−1)W/2(t−u) is determined and a close attention should be paid so that a W value to be determined does not exceed the range.

### Other Embodiments

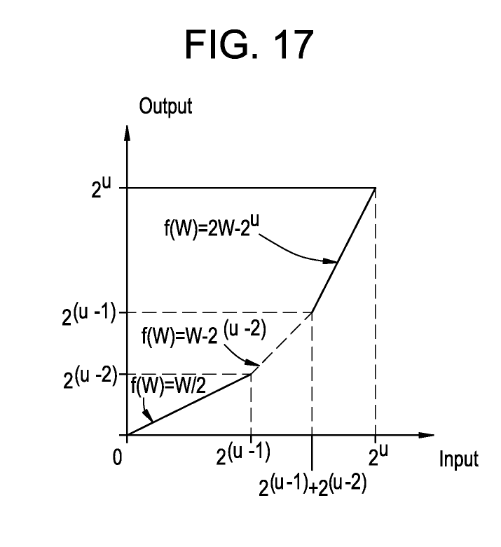

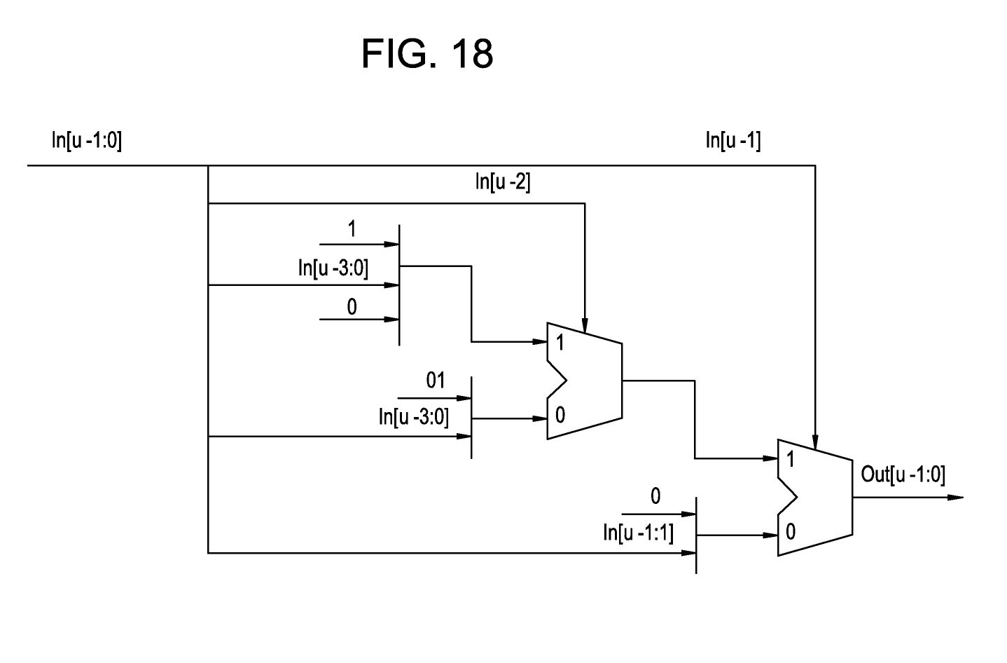

(i) Straight lines to be combined may be more than two lines. For example, when t−u is 1, each straight line satisfies a simple equation as indicated in the figure by combining three straight lines as indicated in FIG. 17 and a simple logic circuit as in FIG. 18 is realized.

When an input data is smaller than 2 (u−1), it satisfies f(W)=W/2. The input data should be shifted lower by 1 bit. Therefore, the u−1 bit is 0, add 0 to the top of the 1st bit to the u−1 bit [u−1:1] of input data to have it selected by a second controller and output as [u−1:0] which is shifted by 1 bit. The two selectors with control input 0, 1 select one of the input values 0, 1 for an output.

When u−2 bit is 0, the first selector selects data with 01 being added to the top of 0˜u−3 bit and u−1 bit and u−2 bit being deleted. Here, an output from the first selector is employed when u−1 bit is 1. u−1 bit is replaced with 0 and u−2 bit is replaced with 1 to calculate and output W−2(u−2).

When the u−2 bit is 1, the first selector selects inputting 1. A data with 1 being added to the top and 0 being added to the lower of 0˜u−3 bit from which u−1 bit and u−2 are removed is input to this input 1. Here, this input is employed only when both u−1 bit and u−2 bit are 1. By adding 0 to the lower side, 1 to the upper side, 2W−2u is calculated to be output.

Moreover, the f(W)=W/2 part satisfies the condition of f(W)=(2n−1)W/2(t−u) and the method described thus far is applicable. The other parts do not satisfy the condition but the error can be made equal to or less than 0.5 by selecting R′, G′, B′ and W values appropriately, and the maximum error does not become worse than when the angle is made the same as that of R′, G′, B′ as a single straight line f(W)=W.

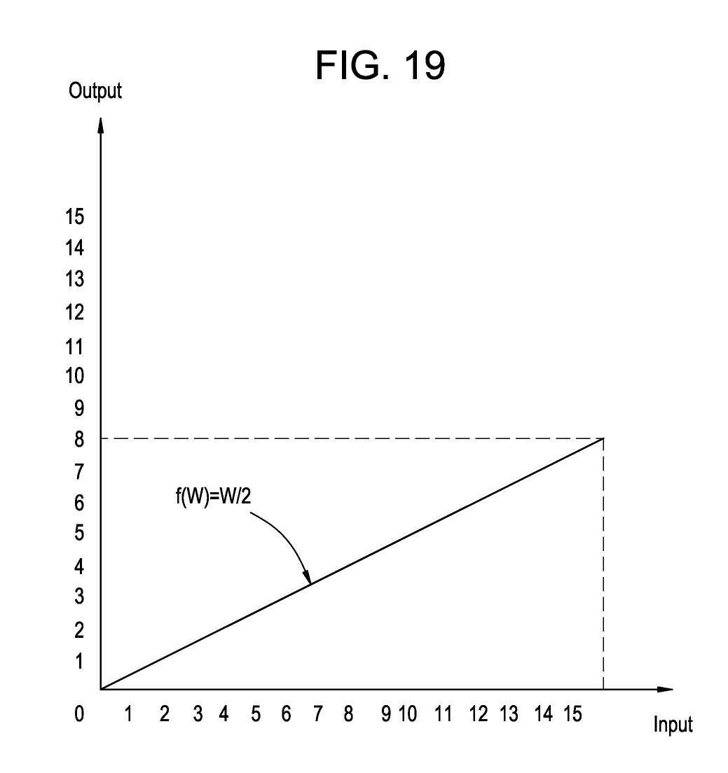

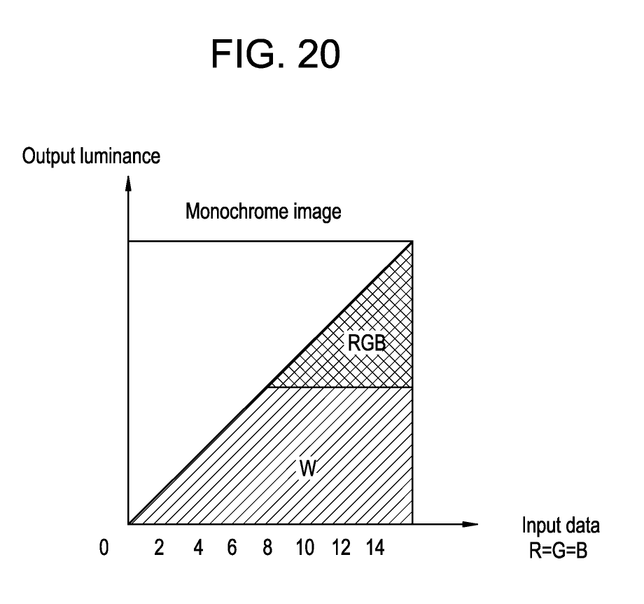

(ii) The input and output characteristics of W may be a single straight line which is different from the angle of R′, G′, B′ and satisfies f(W)=(2n−1)W/2(t−u) (see FIG. 19). When an angle of the input and output characteristics of W is moderate compared to the angle of R′, G′, B′, min(R, G, B) may become greater than RGB element calculated from the maximum value of f(W). In this case, add R′, G′, B′ as much as necessary. That is, when an input white element is smaller than a maximum W, M=1. When an input white element is greater than a maximum W, the M value becomes smaller as the input white element becomes greater. FIG. 20 indicates a usage amount of W and RGB for an input when a monochrome image having all identical R, G, B values is input. In the area above luminescent which can be expressed with a bit number usable by W, it is expressed by RGB.

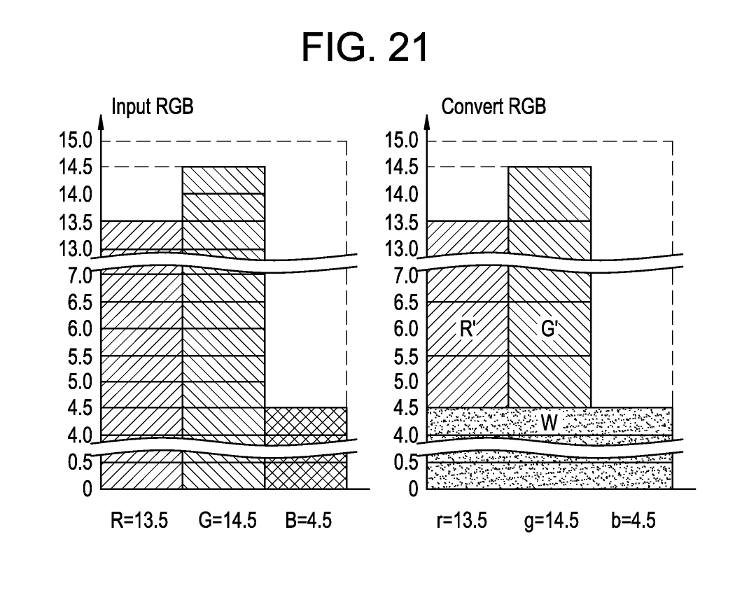

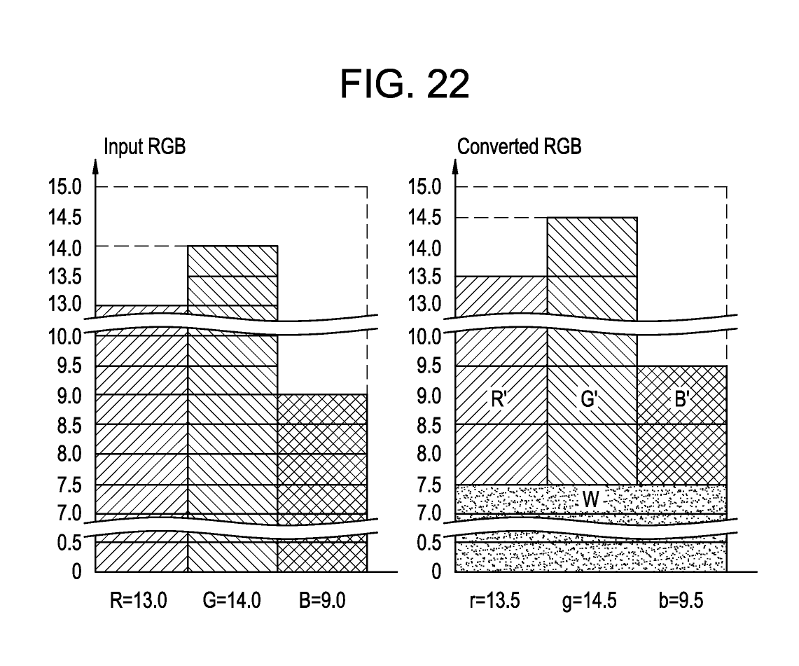

FIG. 21 is a conversion result of inputting R=13.5, G=14.5, B=4.5 and applying f(W) indicated in FIG. 19 when an input RGB has a fractional portion of 1 bit and an integer portion of 4 bit and R′G′B′W is 4 bit, and an example of min(R, G, B) being smaller than the maximum value of f(W). Here, R′, G′, B′, W are 9, 10, 0, 9 respectively. FIG. 22 is a conversion result of inputting R=13.0, G=14.0, B=9.0 and an example of min(R, G, B) being greater than the maximum value of f(W). R′, G′, B′ are obtained from replacing f(W) with a maximum value 7.5 in Equations 42-44, and R′, G′, B′, W are 6, 7, 2, 15 respectively.

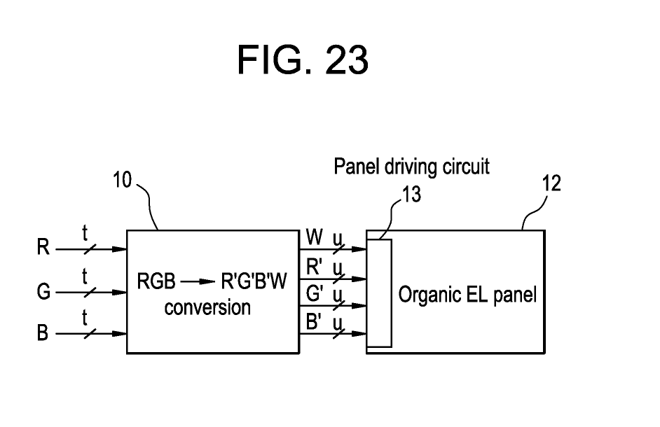

FIG. 23 illustrates a constitution of a display device according to this embodiment. RGB data which is a display target is input to a RGB→R′G′B′W converting section 10 and its output is input to a panel driving circuit 13. This panel driving circuit 13 is, as explained above, made the characteristic curve of the amount of luminescent of W sub pixel for W input data different from the curve of R′G′B′ normalized at a ratio of luminescent necessary for a reproduction of white color with sub pixels of RGB. An appropriate process is carried out by the RGB→R′G′B′W converting section 10 in accordance with the curve of input data from the panel driving circuit verses amount of luminescent to realize a display without disturbing the gradation of input signals as much as possible for input signals having greater gradation numbers than a maximum gradation numbers of organic EL panel (display panel) 12.

### DESCRIPTION OF THE SYMBOLS

10: RGB→R′G′B′W converting section, 12: Organic EL panel, 13 panel driving circuit.

1. A display device which constitutes a pixel using RGBW (red, green, blue, and white) sub-pixel and converts input RGB data into R′G′B′W data for display,
comprising the first conversion means for converting the input RGB data into R′G′B′W data,
the second conversion means for converting the R′G′B′W data into driving signals of the R′G′B′W data which is supplied to a display panel,
characterized in that the bit width of input RGB data is greater than the bit width of converted R′G′B′W in the said first conversion means,
and the characteristic curve of the amount of luminescent of W sub pixel for the input data of W of the second conversion means is different from the R′G′B′ curve normalized at a luminance ratio necessary for a reproduction of white color with sub pixels of RGB.

2. The display device according to claim 1 characterized in that
in the said second conversion means, the characteristic curve of the amount of luminescent for the input data of R′G′B′ which is normalized at a luminance ratio necessary for a reproduction of white color with sub pixels of RGB is a straight line and
the characteristic curve of the amount of luminescent of W sub pixel for the input data of W is a straight line having a different angle from the characteristic curve of R′G′B′.

3. The display device according to claim 1 characterized in that
in the said second conversion means, the characteristic curve of the amount of luminescent for the input data of R′G′B′ which is normalized at a luminance ratio necessary for a reproduction of white color with sub pixels of RGB is a straight line and
the characteristic curve of the amount of luminescent of W sub pixel for the input data of W is a combination of a plurality of straight line having a different angle from the characteristic curve of R′G′B′.

4. In the display device according to claim 2,
a display device characterized in that when the bit width of RGB data which is input in the said first conversion means is t and the bit width of the converted R′G′B′W is u, it is preferred that the angle of at least one straight line of the characteristics of W in the said second conversion means is (2n−1)/2(t−u) (n is a positive integer).

5. The display device according to claim 2 characterized in that the angle of the characteristic curve of the amount of luminescent of W sub pixel for input data of W in the said second conversion means is moderate compared to that of R′G′B, and
when the white element obtained from calculation of input RGB in the said first conversion means is less than the maximum amount of luminescent of W sub pixel, the usage rate of white (W) is made 100% while when the white element is greater than the maximum amount of luminescent of W sub pixel, it is reproduced by the combination of W lighted at its maximum brightness and R′G′B′ sub pixels.

6. The display device according to claim 1 characterized in that
in the said first conversion means, R′G′B′ value and W value are determined so that the absolute value of the sum of values obtained from multiplying weight by each difference between the amount of luminescent of each RGB obtained from calculating each input RGB data and the amount of luminescent of RGB obtained from calculating converted R′G′B′W data is minimum.

7. The display device according to claim 1 characterized in that
in the said first conversion means, R′G′B′ value and W value are determined so that the differences of chromaticity calculated from the amount of luminescent of each RGB obtained from calculating each input RGB data and the amount of luminescent of each RGB obtained from calculating each RGB element in converted R′G′B′W data is minimum.

8. In the display device according to claim 3,
a display device characterized in that when the bit width of RGB data which is input in the said first conversion means is t and the bit width of the converted R′G′B′W is u, it is preferred that the angle of at least one straight line of the characteristics of W in the said second conversion means is (2n−1)/2(t−u) (n is a positive integer).

9. The display device according to claim 2 characterized in that
in the said first conversion means, R′G′B′ value and W value are determined so that the absolute value of the sum of values obtained from multiplying weight by each difference between the amount of luminescent of each RGB obtained from calculating each input RGB data and the amount of luminescent of RGB obtained from calculating converted R′G′B′W data is minimum.

10. The display device according to claim 3 characterized in that
in the said first conversion means, R′G′B′ value and W value are determined so that the absolute value of the sum of values obtained from multiplying weight by each difference between the amount of luminescent of each RGB obtained from calculating each input RGB data and the amount of luminescent of RGB obtained from calculating converted R′G′B′W data is minimum.

11. The display device according to claim 4 characterized in that
in the said first conversion means, R′G′B′ value and W value are determined so that the absolute value of the sum of values obtained from multiplying weight by each difference between the amount of luminescent of each RGB obtained from calculating each input RGB data and the amount of luminescent of RGB obtained from calculating converted R′G′B′W data is minimum.

12. The display device according to claim 8 characterized in that
in the said first conversion means, R′G′B′ value and W value are determined so that the absolute value of the sum of values obtained from multiplying weight by each difference between the amount of luminescent of each RGB obtained from calculating each input RGB data and the amount of luminescent of RGB obtained from calculating converted R′G′B′W data is minimum.

13. The display device according to claim 5 characterized in that
in the said first conversion means, R′G′B′ value and W value are determined so that the absolute value of the sum of values obtained from multiplying weight by each difference between the amount of luminescent of each RGB obtained from calculating each input RGB data and the amount of luminescent of RGB obtained from calculating converted R′G′B′W data is minimum.

14. The display device according to claim 2 characterized in that
in the said first conversion means, R′G′B′ value and W value are determined so that the differences of chromaticity calculated from the amount of luminescent of each RGB obtained from calculating each input RGB data and the amount of luminescent of each RGB obtained from calculating each RGB element in converted R′G′B′W data is minimum.

15. The display device according to claim 3 characterized in that
in the said first conversion means, R′G′B′ value and W value are determined so that the differences of chromaticity calculated from the amount of luminescent of each RGB obtained from calculating each input RGB data and the amount of luminescent of each RGB obtained from calculating each RGB element in converted R′G′B′W data is minimum.

16. The display device according to claim 4 characterized in that
in the said first conversion means, R′G′B′ value and W value are determined so that the differences of chromaticity calculated from the amount of luminescent of each RGB obtained from calculating each input RGB data and the amount of luminescent of each RGB obtained from calculating each RGB element in converted R′G′B′W data is minimum.

17. The display device according to claim 8 characterized in that
in the said first conversion means, R′G′B′ value and W value are determined so that the differences of chromaticity calculated from the amount of luminescent of each RGB obtained from calculating each input RGB data and the amount of luminescent of each RGB obtained from calculating each RGB element in converted R′G′B′W data is minimum.

18. The display device according to claim 5 characterized in that
in the said first conversion means, R′G′B′ value and W value are determined so that the differences of chromaticity calculated from the amount of luminescent of each RGB obtained from calculating each input RGB data and the amount of luminescent of each RGB obtained from calculating each RGB element in converted R′G′B′W data is minimum.
